(19) United States
(12) Patent Application Publication
(10) Pub. No.: US 2026/0203693 A1
(43) Pub. Date: Jul. 16, 2026

(54) MACHINE LEARNING-BASED PROJECT RISK PREDICTION WITH CONFLICT HANDLING AND DECISION EXPLANATION

(71) Applicant: International Business Machines Corporation, Armonk, NY (US)

(72) Inventors: Tania BANERJEE, Pune (IN); Angelo MOORE, Dunboyne (IE); Yu Juan YIN, Shanghai (CN); Vytautas BIELINSKAS, Druskininkai (LT)

(21) Appl. No.: 19/016,228

(22) Filed: Jan. 10, 2025

(51) Int. Cl. G06Q 10/0635; G06Q 10/10

(52) U.S. Cl. CPC G06Q 10/0635; G06Q 10/103

(57) ABSTRACT

The present disclosure provides a method for machine learning-based project risk prediction. The method includes training a first tree-based machine learning (ML) model using historical project delivery data to generate one or more risk-related predictions for project performance, determining a plurality of input features from the historical project delivery data, identifying a first value range for a first input feature, where contributions of the first input feature to one or more of the risk-related predictions, within the first value range, exhibit inconsistency that exceeds a defined threshold, training a second tree-based ML model using the historical project delivery data to identify a second input feature, where a combination of the first and second input features resolves the inconsistent contributions of the first input feature within the first value range, and generating a knowledge base table comprising the combination of the first and second input features.

### BACKGROUND

The present invention relates to machine learning (ML)-based project risk prediction, and more specifically, to identifying and resolving conflicts in feature contributions within trained ML models and generating plain-language explanations for decision-making.

### SUMMARY

One embodiment presented in this disclosure provides a method, including training a first tree-based machine learning (ML) model using historical project delivery data as input data to generate one or more risk-related predictions for project performance, determining a plurality of input features from the historical project delivery data, identifying, based on one or more decision paths within the first tree-based ML model, a first value range for a first input feature, among the plurality of input features, where a contribution of the first input feature to one or more of the risk-related predictions, within the first value range, is determined, and the contributions of the first input feature exhibit inconsistency exceeding a defined threshold, training a second tree-based ML model using the historical project delivery data as input data to identify a second input feature, where a combination of the first input feature and the second input feature resolves the inconsistent contributions of the first input feature, within the first value range, and generating a knowledge base table comprising at least one of the first input feature, the second input feature, the first value range for the first input feature, and the combination of the first input feature and the second input feature.

Other embodiments in this disclosure provide computer-readable media containing computer program code that, when executed by operation of a computer system, performs operations in accordance with one or more of the above methods, as well as systems comprising one or more memories collectively containing one or more programs, and one or more processors, where the one or more processors are configured to, individually or collectively, perform an operation in accordance with one or more of the above methods.

### BRIEF DESCRIPTION OF THE DRAWINGS

FIG. 1 depicts an example computing environment for the execution of at least some of the computer code involved in performing the inventive methods.

FIG. 2 depicts an example workflow for identifying and segmenting feature contributions in ML models for conflict handling, according to some embodiments of the present disclosure.

FIG. 3 depicts an example workflow for generating predictions and retrieving explanations for real-time project delivery data using trained ML models, according to some embodiments of the present disclosure.

FIG. 4 depicts an example knowledge base table, according to some embodiments of the present disclosure.

FIGS. 5A and 5B depict an example method for analyzing feature contributions in predictive modeling, according to some embodiments of the present disclosure.

FIG. 6 depicts an example method for generating predictions and resolving feature conflicts for new project data, according to some embodiments of the present disclosure.

FIG. 7 is a flow diagram depicting an example method for feature contribution analysis, according to some embodiments of the present disclosure.

### DETAILED DESCRIPTION

Analytics modeling based on machine learning (ML) models is becoming increasingly prominent across various industries. For example, in banking, ML models are utilized for credit risk assessment during the loan approval process. In the finance industry, these models are applied for fraud detection or investment analysis. Additionally, in IT service delivery, the models are used to predict project success rates. The rapid growth of ML applications is driven by several factors, including the availability of large amounts of high-quality data, the availability of relatively inexpensive high-capacity computing resources, and the development of many advanced algorithms for classification, prediction, and decision-making. These factors together have enabled ML models to solve complex problems with increasing accuracy and efficiency.

However, despite this growth and increasing awareness of ML models in the social consciousness, several sociological factors still hinder their broad acceptance and adoption. Among these are issues for trust and explainability, and more specifically, how ML model arrive at decisions or forecasts, and whether these outputs are explainable, transparent, fair, and understandable. Addressing these concerns is important for building trust and driving wider adoption of ML technologies.

The present disclosure introduces a system and method designed to address these challenges by improving the explainability and transparency of prediction outputs. The disclosed approach focuses on making ML model outputs more interpretable to users while maintaining high predictive accuracy and performance. To maintain high accuracy, in one embodiment, the system trains ML models on large amounts of historical project delivery data. To achieve explainability and, in one embodiment, the disclosed system integrates interpretability frameworks that highlight and/or quantify the contribution of individual features to a given prediction or decision. For example, in one embodiment, the system utilizes tree interpreter techniques to identify specific features, and determine whether an individual feature has a positive or negative influence on the risk prediction when falling within a specific value range. When varying contributions or influences (positive or negative) are identified for a feature (e.g., inconsistent influence exceeding a predefined threshold), in one embodiment, the system trains a secondary ML model to perform a deeper feature contribution analysis. This secondary model isolates the impact of the flagged feature by excluding it from the dataset and analyzes the contributions of other features. The secondary model particularly focuses on identifying features that correlate strongly with the observed variation in the flagged feature's contributions. By doing so, the system determines secondary features that stabilize or explain the inconsistencies observed in the flagged feature's contributions. Upon identification, the system then combines the contributions of the identified primary and secondary features to form a composite reasoning. This composite reasoning provides a clearer explanation of how feature interactions influence the risk prediction. Finally, in one embodiment, the system saves reason codes and plain-language explanations in a knowledge base table, associating these contents with the identified individual features (or composite features) and their respective value ranges. When new project delivery data is received, the system processes the data using the trained ML model to generate risk predictions. Since feature value ranges and contributions are pre-identified, the system further examines the values of features in the real-time project delivery data to match them with corresponding value ranges stored in the knowledge base table. Once a match is found, the relevant explanation, along with the associated reason code, is retrieved and output to provide additional context and transparency for the final prediction results.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

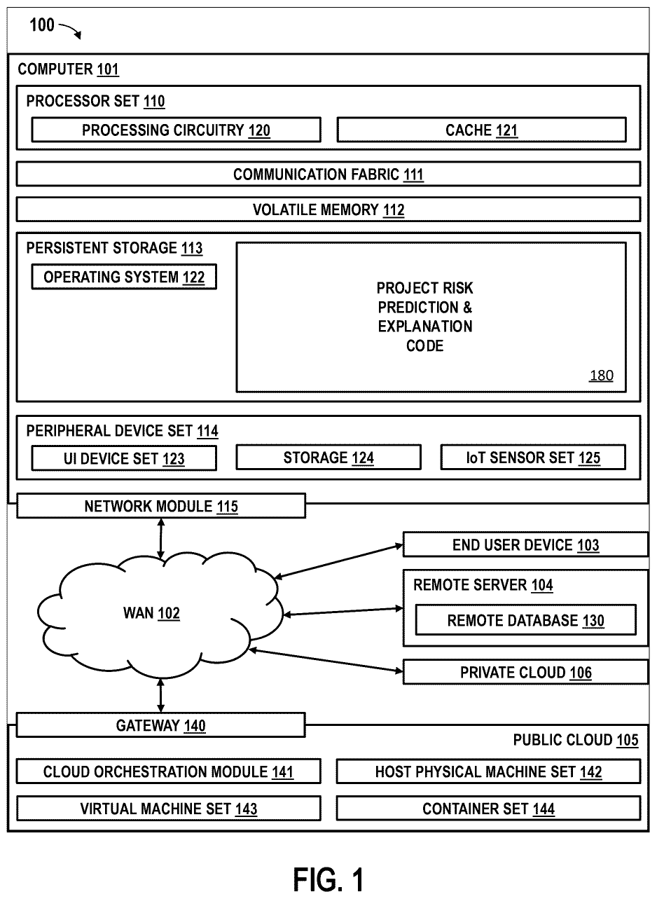

FIG. 1 depicts an example computing environment 100 for the execution of at least some of the computer code involved in performing the inventive methods.

Computing environment 100 contains an example of an environment for the execution of at least some of the computer code involved in performing the inventive methods, such as Project Risk Prediction & Explanation Code 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Project Risk Prediction & Explanation Code 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch, or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Project Risk Prediction & Explanation Code 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in Project Risk Prediction & Explanation Code 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private cloud 106 and public cloud 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

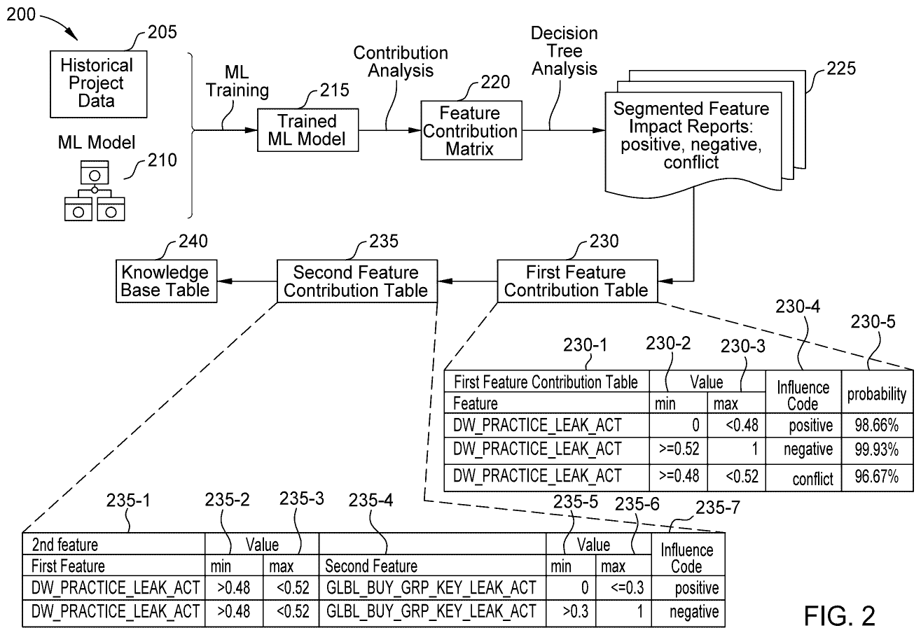

FIG. 2 depicts an example workflow 200 for identifying and segmenting feature contributions in ML models for conflict handling, according to some embodiments of the present disclosure.

As depicted, the workflow 200 begins by using historical project delivery data 205 and provided machine learning (ML) algorithms 210 (e.g., basic Random Forest models or other default ML models) to train a primary (or first) ML model 215. As used herein, the designation of this model 215 as “primary” or “first” does not imply it is required or critical feature for the disclosed system. Instead, these terms are used to identify the model as an initial framework for conducting data analysis and generating risk-related predictions. The historical project delivery data 205 may include information related to financial performance, operational performance, resource utilization, past risk results, and other relevant project attributes. The primary (or first) ML model 215 is trained to generate risk-related outputs, such as a risk score (e.g., 97.5), a probability of achieving the target gross profit (GP) (e.g., 2.5%), a classification of risk levels (e.g., low, medium, high), a predicted impact to plan (e.g., missing the financial goal by more than $500K), or other suitable risk-related metrics (depending on the application).

Once the primary (or first) ML model 215 is trained, contribution analysis is performed to generate a feature contribution matrix 220. This matrix 220 lists individual features and quantifies their contributions to the risk-related outputs. As used herein, the contributions may be represented in terms of magnitude (how strongly the feature affects the prediction) (e.g., increase the risk score by 0.2), probability (the likelihood or confidence that the feature affects the prediction) (e.g., 95%), and influence directionality (whether the feature has a positive or negative effect on the risk). Following the contribution analysis, the system performs decision tree analysis on the feature contribution matrix 220 to generate segmented feature impact reports 225. These reports 225 segment the value range of each feature and categorize each feature's influence on the risk predictions (e.g., positive, negative, conflicting). For an example input feature “DW_PRACTICE_LEAK_ACT,” which represents the percentage of historical projects within the same offering that showed a high risk of not meeting their target gross profit (GP), the decision tree analysis may reveal the following information for this feature: when the feature's value is between 0 and 0.48, the feature “DW_PRACTICE_LEAK_ACT” has a negative contribution to risk (e.g., lowing the risk score); when the value falls within between 0.52 and 1, this feature has a positive contribution to risk (e.g., increasing the risk score); and when the value is between 0.48 and 0.52, the contribution is inconsistent, with conflicting results observed. This information is then compiled into the segmented feature impact reports 225, which provide a clear and structured understanding of how individual features influence risk predictions within specific value ranges.

From the segmented feature impact reports 225, the system generates a first feature contribution table 230. As depicted, the table 230 includes columns for the feature name 230-1, minimum value 230-2, maximum value 230-3, influence code 230-4, and probability 230-5. The feature name column 230-1 identifies the specific feature being analyzed. In some embodiments, the feature name may be a predefined term or acronym used in the system to describe a project attribute (or input feature) (e.g., “DW_PRACTICE_LEAK_ACT” that represents the percentage of historical projects within the same offering that showed a high risk of not meeting their target GP), or may be a (brief) natural language description of the feature. The maximum value and minimum value columns 230-2 and 230-3 represent the range of values for the feature within which the feature's contribution is analyzed. The minimum value column 230-2 indicates the lower bound of the range, while the maximum value column 230-3 indicates the upper bound. In some embodiments, these ranges may be determined through the decision tree analysis by examining the decision paths in the trained ML model 215. These bounds may be inclusive or exclusive, depending on the particular embodiment. The influence code column 230-4 captures the type (or direction) of impact the feature has within the specified value range. As depicted, the influence code may include positive (indicating that the feature increases the risk prediction in the range), negative (indicating that the feature decreases the risk prediction in the range), and conflicting (indicating that the feature shows inconsistent contributions, making its influence unclear in the range). The influence code provides classification about the feature's role in risk predictions. For example, as depicted, the “DW_PRACTICE_LEAK_ACT” feature has a consistent positive influence within the range between 0 and 0.48, a consistent negative influence within the range between 0.52 and 1, and a conflicting influence within the range between 0.48 and 0.52. The probability column 230-5 represents the confidence or likelihood that the feature's contribution behaves as described in the influence code within the specified value range. As depicted, a probability of 98.66% indicates high confidence that the “DW_PRACTICE_LEAK_ACT” feature has a consistent positive influence within the range between 0 and 0.48.

Upon identifying the ranges with conflicting (or inconsistent) contributions (e.g., 0.48-0.52 for “DW_PRACTICE_LEAK_ACT”), the system proceeds to train a secondary ML model (e.g., a decision tree model), and identify whether there is a secondary feature that can resolve the current inconsistencies. In some embodiments, the secondary ML model is trained using only the data samples where the first feature (e.g., “DW_PRACTICE_LEAK_ACT”) falls within the conflicting range (e.g., 0.48-0.52). During training, the first feature itself is excluded from the dataset to isolate the first feature's contributions to the predictions. For example, if the full training dataset contains 10,000 samples, and only 500 samples are used to train the secondary model. The first feature itself (e.g., “DW_PRACTICE_LEAK_ACT”) is excluded as an input when training the secondary model. This ensures that the secondary model focuses on analyzing the contributions of other features without bias from the conflicting first feature. For example, the secondary model may evaluate whether a feature like “GLBL_BUY_GRP_KEY_LEAK_ACT” (representing the experience level with the current buying group) provides stable contributions within its specific value ranges (e.g., 0-0.3, or 0.3-1) that explain or stabilize the inconsistencies in the first feature's conflicting range. As used herein, the designation of this model as “secondary” or “second” does not imply that the model is less important or subordinate to the primary ML model. Instead, the designation only indicates the sequence in which the model is trained and used for risk analysis. The primary (or first) model focuses on initial risk predictions, while the secondary model addresses specific inconsistencies identified during the primary analysis.

In some embodiments, the system may perform contribution analysis and decision tree analysis on the secondary model to determine which secondary features (also referred to in some embodiments as second features) strongly correlate with and potentially resolve the inconsistencies observed in the first feature's contributions. The findings may be recorded in the segmented feature impact reports, similar to the report generated for the first feature. From the reports, the system may generate a second feature contribution table 235.

As depicted, the second feature contribution table 235 extends the information from the first table to include secondary feature contributions. The table includes columns for the first feature name 235-1, the first feature's minimum value 235-2, the first feature's maximum value 235-3, the second feature name 235-4, the second feature's minimum value 235-5, the second feature's maximum value 235-6, and the influence code 235-7. As depicted, the first feature is identified as “DW_PRACTICE_LEAK_ACT,” which has a conflicting range between 0.48 and 0.52. The second feature is “GLBL_BUY_GRP_KEY_LEAK_ACT”, which resolves the inconsistencies in the first feature's contributions. As used herein, the “GLBL_BUY_GRP_KEY_LEAK_ACT” represents the level of experience with the current buying groups. When the first feature's value falls within 0.48-0.52, and the second feature's value is between 0 and 0.3, the contribution is positive, increasing the risk prediction in this context. Conversely, when the second feature's value falls within 0.3-1, the contribution is negative, lowering risk prediction. It is important to note that a value between 0-0.3 for the second feature alone (e.g., when the other feature has a value outside of the inconsistent range identified for the first feature) may not exhibit the same correlation or impact on the model. Similarly, a value between 0.3-1 for the second feature alone (e.g., when the other feature's value is outside the consistent range) may also result in different correlations or impacts compared to its behavior within the flagged range of the first feature. Through the second feature contribution table 235, the system may identify how the second feature (“GLBL_BUY_GRP_KEY_LEAK_ACT”) influences the risk prediction within the context of the flagged range of the first feature (“DW_PRACTICE_LEAK_ACT”).

In some embodiments, the secondary model and corresponding contribution table 235 may be generated for features that exhibit inconsistent contributions. Specifically, the primary model may initially be used to evaluate the contributions of each feature, and a respective secondary model may then be trained for any feature having at least one inconsistent influence range. The selective training approach for features that exhibit inconsistences may reduce computational expenses and avoid unnecessary modeling. This approach ensures computational resources are efficiently allocated, as the system refrains from training secondary models for features with consistent contributions. For example, after collecting the initial data and training the primary model, the system identifies only those features requiring further analysis and limits secondary modeling to those embodiments. The selective strategy minimizes (at least reduces) computational waste and align with resource-efficient model design principles.

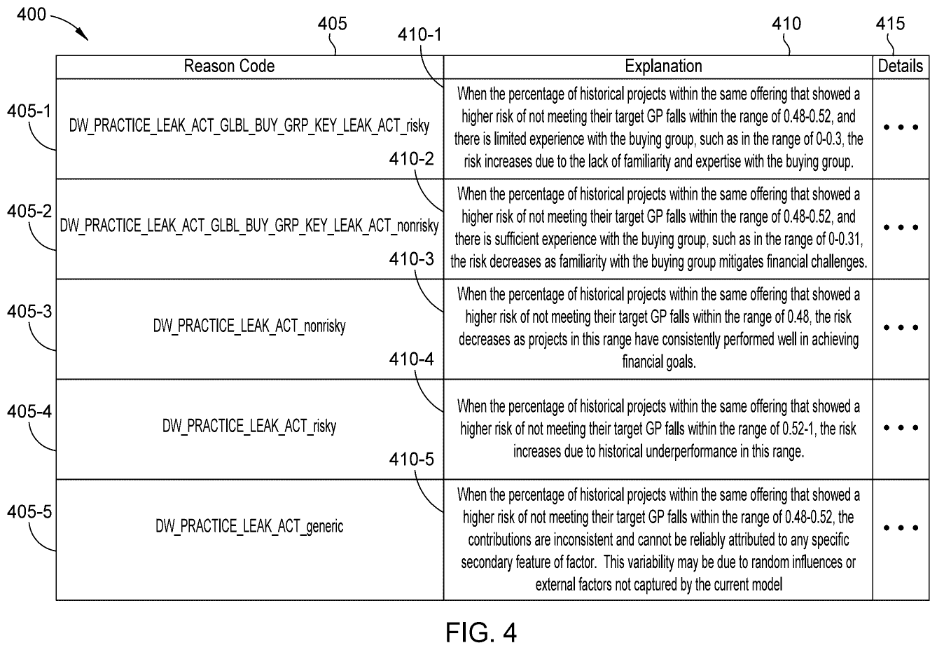

Upon identifying the first and/or second features and determining their individual and/or combined contributions, the system generates a reason code and a plain-language explanation for each contribution or combination. The reason codes follow a structured format, identifying involved features and summarizing their combined influence. The plain-language explanation provides an interpretable description of how the identified features and their value ranges contribute to the risk prediction. For example, if the first feature “DW_PRACTICE_LEAK_ACT” falls within 0.48-0.52, and the second feature “GLBL_BUY_GRP_KEY_LEAK_ACT” falls within 0-0.3, the reason code may be presented as “DW_PRACTICE_LEAK_ACT_ GLBL_BUY_GRP_KEY_LEAK_ACT_risky” (as depicted as 405-1 in FIG. 4). This code indicates that the combination of the two features increases the risk prediction. Alternatively, if the second feature falls within the range 0.3-1, the reason code may be represented as “DW_PRACTICE_LEAK_ACT_GLBL_BUY_GRP_KEY_LEAK_ACT_nonrisky” (as depicted as 405-2 in FIG. 4), indicating a decrease in risk. When the first feature falls within 0-0.48, the reason code may be represented as “DW_PRACTICE_LEAK_ACT_nonrisky” (as depicted as 405-3 in FIG. 4), where the first feature lowers risk. Alternatively, if the first feature falls within 0.52-1, the reason code may be represented as “DW_PRACTICE_LEAK_ACT_risky” (as depicted as 405-4 in FIG. 4), where the first feature increases risk.

The plain-language explanation linked to each reason code provides interpretable descriptions of the contributions and their context. For example, the explanation for “DW_PRACTICE_LEAK_ACT_GLBL_BUY_GRP_KEY_LEAK_ACT_risky” may state: “When the percentage of historical projects within the same offering that showed a higher risk of not meeting their target GP falls within the range of 0.48-0.52, and there is limited experience with the buying group, such as in the range of 0-0.3, the risk increases” (as depicted as 410-1 in FIG. 4). The explanation for “DW_PRACTICE_LEAK_ACT_risky” may state: “The risk increases as the percentage of historical projects within this range frequently failed to meet their target GP” (as depicted as 410-4 in FIG. 4). These explanations are provided as examples for conceptual clarity. In some embodiments, the explanations may include additional details, such as contextual observations or statistical analysis derived from the data. In some embodiments, these explanations may be automatically generated based on predefined tags and natural language labels associated with the reason codes. In some embodiments, the explanations may be manually written by experts to provide more context-specific details.

The system then saves all relevant data, including the first and second features, their respective value ranges, the reason codes, and the plain-language explanations, into the knowledge base table 240. Using this table, information may be efficiently retrieved and applied to interpret risk predictions for new project delivery data.

In some embodiments, the inconsistencies in the flagged range of the first feature (e.g., 0.48-0.52 for “DW_PRACTICE_LEAK_ACT”) cannot be resolved, as there is no secondary feature or combination of features strongly correlates with or explains the variations. This indicates that the contributions of the first feature within the flagged range are likely influenced by random noise or other factors outside the scope of the current model. In such configurations, the system may classify the flagged range as “unresolved” and document the randomness of the contributions in the knowledge base table 240 to maintain transparency. For the unresolved value range, the system may assign a generic reason code, such as “DW_PRACTICE_LEAK_ACT_generic” (as depicted as 405-5 in FIG. 4), and associate the generic reason code with a plain-language explanation (as depicted as 410-5 in FIG. 4) that acknowledges the lack of clear contributing factors. To perform ongoing improvement, in some embodiments, data samples within this unresolved range may be continuously monitored for patterns or changes over time. If significant new trends or correlations emerge, the system may trigger a process to update (or retrain) the models (e.g., the primary or secondary model, or both) to incorporate these changes. This approach allows the model to adapt dynamically to evolving data and improves its ability to handle previously unresolved inconsistencies.

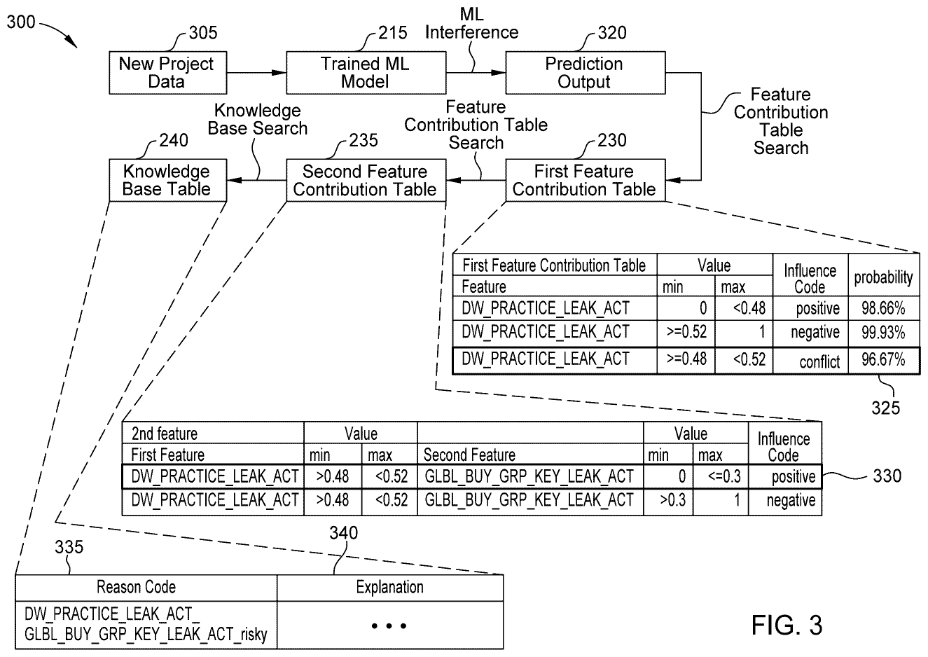

FIG. 3 depicts an example workflow 300 for generating predictions and retrieving explanations for real-time project delivery data using trained ML models, according to some embodiments of the present disclosure.

As depicted, new project delivery data 305 is provided as input for the trained ML model for risk prediction. The trained ML model may comprise the primary (or first) ML model 215 as depicted in FIG. 2, which is trained on historical project data to generate risk-related predictions. The new project delivery data 305 may include a variety of information, such as financial performance indicators (e.g., budget utilization, target GP percentage), operational performance metrics (e.g., resource allocation, timelines), historical trends (e.g., past performance with similar offerings), external factors (e.g., market conditions, client type), and the like. The trained ML model 215 processes the provided project delivery data 305 to generate risk-related predictions 320 in real time. These predictions may include various forms, such as a risk score (e.g., 97.5) indicating the likelihood of risk, a probability of achieving a target GP (e.g., 2.5%), a classification of risk levels (e.g., low, medium, high), or a predicted impact to plan (e.g., missing the financial goal by more than $500K).

After generating the prediction output 320, the system examines the value of the first feature (“DW_PRACTICE_LEAK_ACT”) from the project delivery data 305. The system matches this value to the corresponding range in the first feature contribution table 230. If the value falls within a non-conflicting range (e.g., 0-0.48 or 0.52-1), the system identifies the associated reason code and plain-language explanation directly from the knowledge base table 240. If the value falls within a conflicting range 325 (e.g., 0.48-0.52), the system identifies the need for further analysis and proceeds to the second feature contribution table 235.

As depicted, the first feature's value falls within the conflicting range 325, and the system proceeds to search the second feature contribution table 235. In some embodiments, the system may evaluate the value of the second feature (“GLBL_BUY_GRP_KEY_LEAK_ACT”) and match the value to its respective range (e.g., 0-0.3 or 0.3-1). Based on the comparison, the system may determine the influence (e.g., positive or negative) of the combination of the first and second features.

As depicted, the value of the second feature falls within the range of 0-0.3, and the combination of the first and second features has a positive influence, increasing the risk prediction (as depicted by 330). This determination is then used to retrieve the relevant reasoning data (including the reason code and associated plain-language explanation).

Based on the identified feature value ranges and contributions, the system then queries the knowledge base table 240 to retrieve the reason code 335 and plain-language explanation 340. For non-conflicting first feature ranges (e.g., 0-0.48 or 0.52-1), the reason code and explanation directly reflect the influence of the first feature. For conflicting ranges (e.g., 0.48-0.52), the retrieved information reflects the combined influence of the first and second features. As depicted here, since the first value falls within the conflicting range of 0.48-0.52 and the second feature value falls within 0-0.3, the reason code retrieved is “DW_PRACTICE_LEAK_ACT_GLBL_BUY_GRP_KEY_LEAK_ACT_risky” 335. The corresponding plain-language explanation 340 may state: “When the historical projects show a higher risk of not meeting target GP and there is limited experience with the buying group, the risk increases.”

The system outputs the prediction (e.g., risk score, probability, or classification) along with the associated reason code and/or plain-language explanation. Every feature contributing to the prediction may be identified through the decision tree analysis, with reason codes and plain language explanations generated to facilitate a deeper understanding of the underlying drivers of the prediction. These results may be presented to users through a user interface (UI), such as a dashboard displaying the prediction score, associated reason code, and/or explanation in a structured table format. This allows the users to understand the factors driving the prediction, and therefore take corresponding actions for managing project risks. In some embodiments, the dashboard may provide an overall risk assessment at a high level, such as a cumulative risk score (e.g., 97.5) or a classification of risk level (e.g., low, medium, or high). The dashboard may also include a drill-down function, allowing users to explore individual factors or combinations of factors that contribute to the overall risk. For example, selecting a specific feature or feature pair may display a detailed breakdown of their respective contributions, along with the associated value ranges. On the left or right side of the dashboard, a highlighted text box may provide the plain-language explanation and/or reason code for the selected factor or combination.

In some embodiments, the inconsistencies in the conflicting value range of the first feature (e.g., 0.48-0.52) cannot be resolved, and the second feature contribution table 235 does not provide a clear influence for a specific range (e.g., 0-0.3 or 0.3-1). In such a configuration, the system may retrieve a generic reason code and/or its corresponding explanation from the knowledge base table 240.

FIG. 4 depicts an example knowledge base table 400, according to some embodiments of the present disclosure.

The knowledge base table 400 includes three columns: reason code 405, explanation 410, and other details 415. The reason code column 405 provides a structured identifier that summarizes the specific feature combinations and their influence (e.g., positive or negative) on risk predictions. The explanation column 410 provides a plain-language interpretation of the influence described by the reason code, offering user a clear understanding of the factors contributing to the risk prediction. The other details column 415 contains additional contextual information to improve interpretability, such as statistical data or references to historical trends.

When the first feature (“DW_PRACTICE_LEAK_ACT”) falls within the range of 0-0.48, the reason code 405-3 “DW_PRACTICE_LEAK_ACT_nonrisky” is retrieved, and the associated plain-language explanation 410-3 states: “When the percentage of historical projects within the same offering that showed a higher risk of not meeting their target GP falls within the range of 0-0.48, the risk decreases as projects in this range have consistently performed well in achieving financial goals.” When the first feature falls within the range 0.52-1, the reason code 405-4 “DW_PRACTICE_LEAK_ACT_risky” is retrieved, with the plain-language explanation 410-4, such as: “When the percentage of historical projects within the same offering that showed a higher risk of not meeting their target GP falls within the range of 0.52-1, the risk increases due to historical underperformance in this range.”

For conflicting ranges, the retrieved reason codes reflect the combined influence of the first and second features. For example, if the first feature is within 0.48-0.52 and the second feature (“GLBL_BUY_GRP_KEY_LEAK_ACT”) is within 0-0.3, the reason code “DW_PRACTICE_LEAK_ACT_GLBL_BUY_GRP_KEY_LEAK_ACT_risky” 405-1 is retrieved, with an explanation 410-1, such as: “When the percentage of historical projects within the same offering that showed a higher risk of not meeting their target GP falls within the range of 0.48-0.52, and there is limited experience with the buying group, such as in the range of 0-0.3, the risk increases due to the lack of familiarity and expertise with the buying group.” Conversely, if the second feature is within 0.3-1, the reason code 405-2 “DW_PRACTICE_LEAK_ACT_GLBL_BUY_GRP_KEY_LEAK_ACT_nonrisky” is retrieved, with an explanation 410-2, such as: “When the percentage of historical projects within the same offering that showed a higher risk of not meeting their target GP falls within the range of 0.48-0.52, and there is sufficient experience with the buying group, such as in the range of 0.3-1, the risk decreases as familiarity with the buying group mitigates potential challenges.” In embodiments where inconsistencies remain unresolved, the reason code 405-5 “DW_PRACTICE_LEAK_ACT_generic” is retrieved, with an explanation 410-5, such as “When the percentage of historical projects within the same offering that showed a higher risk of not meeting their target GP falls within the range of 0.48-0.52, the contributions are inconsistent and cannot be reliably attributed to any specific secondary feature or factor. This variability may be due to random influences or external factors not captured by the current model.”

In some embodiments, the knowledge base table 400 may work in conjunction with the first feature contribution table (e.g., 230 of FIG. 2) and the second feature contribution table (e.g., 235 of FIG. 2) to provide a comprehensive view of feature interactions and their influence on risk predictions. In some embodiments, these three tables may be combined into a single and unified table, which includes columns for the first feature name (e.g., “DW_PRACTICE_LEAK_ACT”), the first feature's value range (e.g., 0.48-0.52), the second feature name (e.g., “GLBL_BUY_GRP_KEY_LEAK_ACT”), the second feature's value range (e.g., 0-0.3), the influence code (e.g., positive, negative, conflicting), the reason code (e.g., “DW_PRACTICE_LEAK_ACT_risky”), the plain-language explanation, and other details.

In some embodiments, the system may repeat the feature contribution analysis iteratively to resolve the remaining inconsistencies and identify combinations involving multiple features (e.g., the first, second, and third features). The combination may not be limited to two features. The system may continue analyzing additional features until a clear and stable contribution is identified for the flagged range. For example, if the first feature (“DW_PRACTICE_LEAK_ACT”) falls within the conflicting range of 0.48-0.52 and no resolution is found using the second feature (“GLBL_BUY_GRP_KEY_LEAK_ACT”), the system may evaluate the contributions of a third feature (“PROJECT_COMPLEXITY_LEVEL”) to refine the explanation. The system may perform contribution and decision tree analyses iteratively, generate segmented impact reports, and update the knowledge base table accordingly.

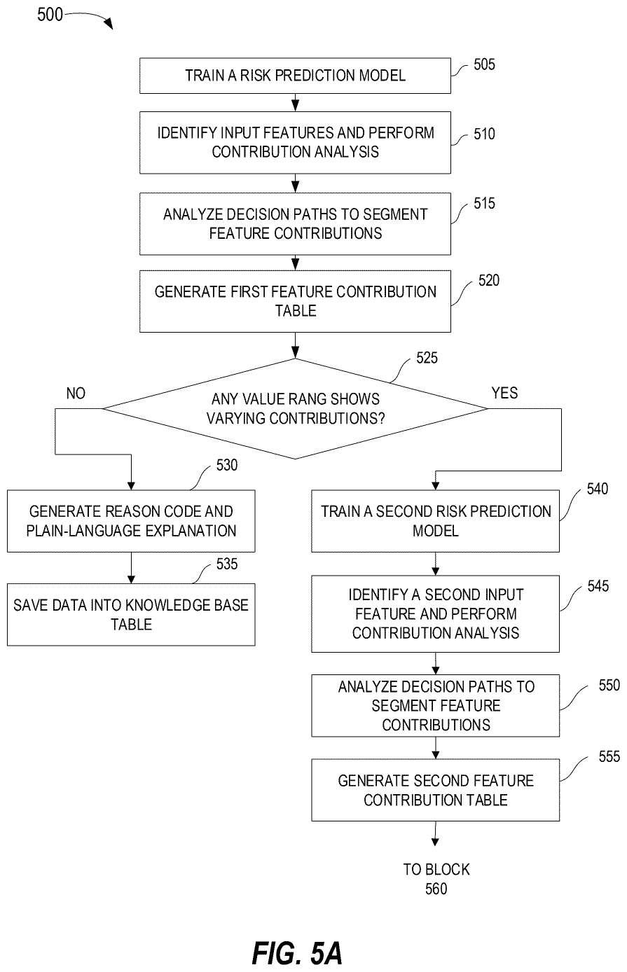

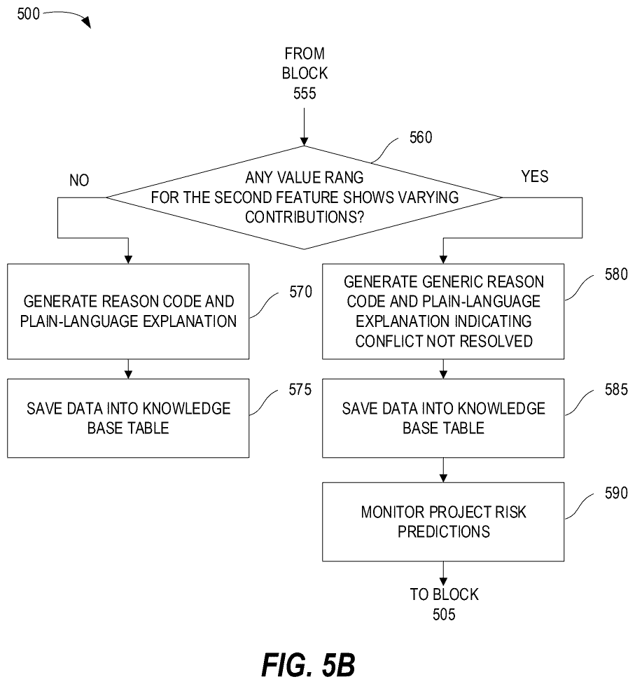

FIGS. 5A and 5B depict an example method 500 for analyzing feature contributions in predictive modeling, according to some embodiments of the present disclosure. In some embodiments, the method 500 may be performed by one or more computing devices or systems, such as the computer 101 as depicted in FIG. 1.

At block 505 of FIG. 5A, a computing system trains a ML model (e.g., a random forest model) using historical project delivery data (e.g., 205 of FIG. 2). The model is trained to predict risk-related outputs (e.g., risk scores, probabilities of achieving target GP, or classifications of risk levels).

At block 510, the computing system identifies the input features used by the model and performs contribution analysis to evaluate how each feature influences the risk prediction. In some embodiments, contributions may be measured in terms of magnitude, influence (e.g., positive or negative), and probability.

At block 515, the computing system analyzes the decision paths within the trained ML model to segment feature contributions into distinct value ranges. Within the identified ranges, each feature has consistent contributions to the risk predictions.

At block 520, the system generates the first feature contribution table (e.g., 230 of FIG. 2). In some embodiments, the first feature contribution tables may include columns for the feature name (e.g., “DW_PRACTICE_LEAK_ACT”), value ranges (e.g., 0-0.48, 0.48-0.52, and 0.52-1), influence code (e.g., positive, negative, or conflicting), and probabilities (e.g., 98.5%).

At block 525, the system checks whether any value ranges in the first feature contribution table include varying contributions (e.g., inconsistent influence exceeding a defined threshold). In some embodiments, the threshold may be defined based on a percentage of the overall training dataset, such as 1% of all data samples showing inconsistent influences within the identified value range. If no such variation exists, indicating that each feature has a consistent contribution across its value ranges, the method 500 proceeds to block 530. If such variation exists, indicating there may be a conflicting contribution in the identified value range, the method 500 moves to block 540. The selective approach, where further analysis is conducted only for features with conflicting contributions, avoids unnecessary modeling and reduces computational expense both at runtime and during the training process.

At block 530, for value ranges without varying contributions, the system generates reason codes and plain-language explanations based on the segmented contributions of the first feature. For example, for the value of the first feature (“DW_PRACTICE_LEAK_ACT”) falling within 0-0.48, a reason code “DW_PRACTICE_LEAK_ACT_nonrisky” (e.g., 405-3 of FIG. 4) is generated, along with a plain-language explanation (e.g., 410-3 of FIG. 4). If the value falls within the range of 0.52-1, a reason code “DW_PRACTICE_LEAK_ACT_risky” (e.g., 405-4 of FIG. 4) is generated, accompanied by a plain-language explanation (e.g., 410-4 of FIG. 4).

At block 535, the system saves the generated data into the knowledge base table (e.g., 240 of FIG. 2). In some embodiments, the knowledge base table may include the reason codes (e.g., “DW_PRACTICE_LEAK_ACT_risky” and “DW_PRACTICE_LEAK_ACT_nonrisky”), plain-language explanations, associated value ranges, and other relevant details.

If varying contributions are identified in the first feature contribution table at block 525, indicating potential conflicts in a specific value range, the method 500 proceeds to block 540. At block 540, the computing system trains a second ML model using data samples where the first feature's values falls within the conflicting range (e.g., 0.48-0.52 for “DW_PRACTICE_LEAK_ACT”). Additionally, the system excludes the first feature from the training datasets for the second model, allowing the second model to analyze the contributions of other features without being influenced by the first feature in the flagged range. The second model may also be a tree-based model like random forest, and use decision tree structure to identify patterns and relationships in the remaining features that might explain the conflict. In some embodiments, the second model may also be referred to as a feature-specific model, as it is trained specifically to address the inconsistency observed with respect to a feature in the first model (e.g., “DW_PRACTICE_LEAK_ACT_risky”). To achieve this, the feature-specific model excludes the observed feature from evaluation and focuses on data samples where the feature's value falls within the identified inconsistency range (e.g., 0.48-0.52).

At block 545, the computing system identifies a second input feature (e.g., “GLBL_BUY_GRP_KEY_LEAK_ACT”), and performs contribution analysis for the second model to evaluate its influence on the predictions within the conflicting range (e.g., 0.48-0.52 for “DW_PRACTICE_LEAK_ACT”).

At block 550, the system analyzes the decision paths within the second ML model to segment the second feature's contributions into distinct value ranges (e.g., 0-0.3 or 0.3-1).

At block 555, the system generates the second feature contribution table (e.g., 235 of FIG. 2). In some embodiments, the second feature contribution table may include columns for the first feature name, the first feature's value range, the second feature name, the second feature's value range, and influence code (e.g., positive, negative, or conflicting).

Turning to FIG. 5B, at block 560, the system determines whether any value range in the second feature contribution table still exhibits varying contributions. If the conflicting contributions remain unresolved, the method 500 proceeds to block 580, where the system generates a generic reason code (e.g., “DW_PRACTICE_LEAK_ACT_generic”) and a plain-language explanation, indicating that the inconsistencies have not been resolved, possibly due to random variations or external factors. Following that, at block 585, the system saves the unresolved contributions, generic reason code, and explanations into the knowledge base table. At block 590, the computing system continues to monitor project risk predictions and identifies trends or changes in the received data. If significant deviations from expected patterns are identified, the method 500 returns to block 505 of FIG. 5A, where the system retrains the ML models (e.g., the primary or secondary model, or both) using the updated data. After retraining, the system performs a new round of contribution and decision tree analyses to determine if previously unresolved inconsistencies can now be resolved. The iterative approach allows the model to remain adaptive to evolving project data and address prior limitations when sufficient new information becomes available.

For value ranges of the second feature that show consistent contributions, at block 570, the system generates specific reason codes and plain-language explanations reflecting the combined influence of the first and second features. For example, if the second feature's value falls within 0-0.3 while the first feature's value is within the conflicting range of 0.48-0.52, and the combination has a consistent positive influence (increasing risk), the reason code like “DW_PRACTICE_LEAK_ACT_GLBL_BUY_GRP_KEY_LEAK_ACT_risky” (e.g., 405-1 of FIG. 4) is assigned. The associated plain-language explanation (e.g., 410-1 of FIG. 4) may indicate that the risk increases due to a high risk observed from historical project records and limited experience with the buying groups. If the second feature's value falls within 0.3-1 while the first feature's value remains within 0.48-0.52, and the combination has a negative influence (reducing risk), a reason code like “DW_PRACTICE_LEAK_ACT_GLBL_BUY_GRP_KEY_LEAK_ACT_nonrisky” (e.g., 405-2 of FIG. 4) is assigned. The associated plain-language explanation (e.g., 410-2 of FIG. 4) may indicate that the risk decreases due to positive contribution from historical project records and sufficient experience with the buying groups. At block 575, the system saves the generated data, including the reason codes, plain-language explanations, and the associated feature value ranges, into the knowledge base table (e.g., 240 of FIG. 2).

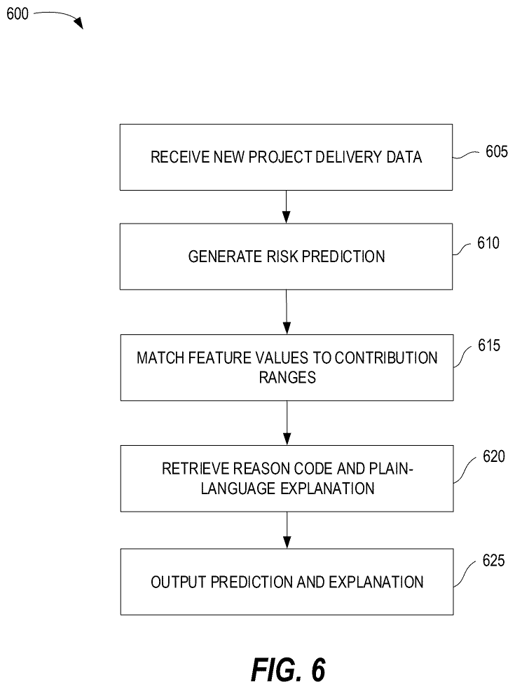

FIG. 6 depict an example method 600 for generating predictions and resolving feature conflicts for new project data, according to some embodiments of the present disclosure. In some embodiments, the method 600 may be performed by one or more computing devices or systems, such as the computer 101 as depicted in FIG. 1.

At block 605, a computing system receives new project delivery data (e.g., 305 of FIG. 3), which serves as input for the trained ML model (e.g., 215 of FIG. 2) for risk prediction. The data may include various metrics and features relevant to project performance, such as financial indicators, operational metrics, historical trends, and external factors.

At block 610, the trained ML model processes the provided data to generate a risk-related prediction. The prediction may include as a risk score (e.g., 97.5), a probability of achieving a target GP (e.g., 2.5%), a classification of risk levels (e.g., low, medium, high), or a predicted impact to plan (e.g., missing the financial goal by more than $500K).

At block 615, the computing system evaluates the feature values in the new project data and matches them to the predefined ranges in the first and second feature contribution tables (e.g., 230 and 235 of FIG. 2). If the first feature's value falls into a non-conflicting range (e.g., 0-0.48 or 0.52-1), the system retrieves the associated reason code and explanation directly from the knowledge base table. If the first feature's value falls into a conflicting range (e.g., 0.48-0.52), the system evaluates the value of the second feature and identifies its matching range in the second feature contribution table.

At block 620, based on the identified feature value ranges, the system retrieves the appropriate reason code and plain-language explanation from the knowledge base table. For example, if the first feature value falls within 0-0.48, the system retrieves the reason code “DW_PRACTICE_LEAK_ACT_nonrisky” and an explanation such as: “The risk decreases due to historical projects performing well in this range.” If the first feature value falls within 0.48-0.52 (which is the conflicting range), and the second feature value is within 0-0.3, the system retrieves the reason code “DW_PRACTICE_LEAK_ACT_ GLBL_BUY_GRP_KEY_LEAK_ACT_risky” and an explanation such as: “The risk increases due to a combination of high historical risk and limited experience with the buying groups.”

At block 625, the system presents the prediction and its associated explanation to a user through a UI. The UI may include a dashboard view that displays the overall risk score or classification, and/or a detailed breakdown view that provides individual or combined feature contributions. Within the UI, it may further contain a text box that summarizes the prediction and provides the plain-language explanation and/or reason code for the selected factor or combination.

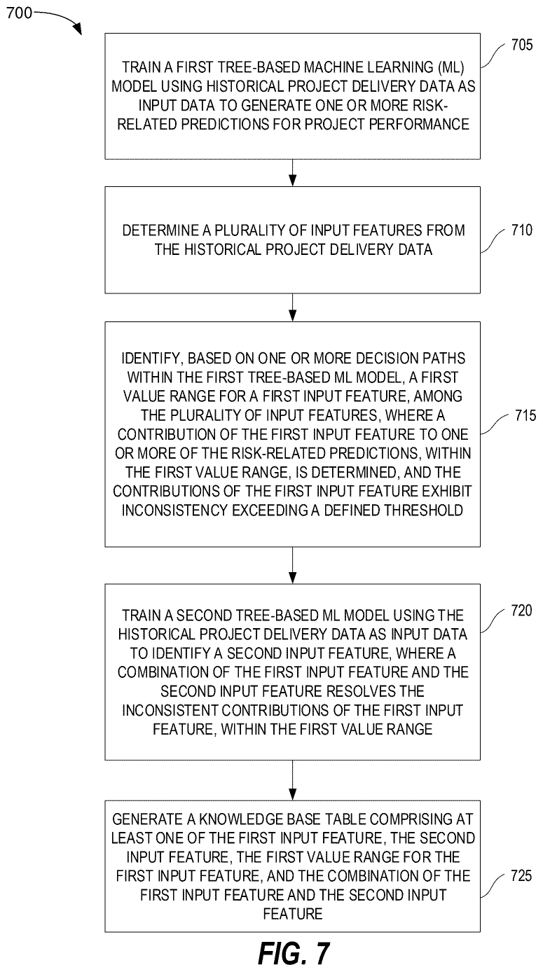

FIG. 7 is a flow diagram depicting an example method 700 for feature contribution analysis, according to some embodiments of the present disclosure.

At block 705, a computing system (e.g., 101 of FIG. 1) trains a first tree-based machine learning (ML) model using historical project delivery data (e.g., 205 of FIG. 2) as input data to generate one or more risk-related predictions for project performance.

At block 710, the computing system determines a plurality of input features from the historical project delivery data (as depicted by block 510 of FIG. 5).

At block 715, the computing system identifies, based on one or more decision paths within the first tree-based ML model, a first value range for a first input feature (e.g., 0.48-0.52 for “DW_PRACTICE_LEAK_ACT”), among the plurality of input features, where a contribution of the first input feature to one or more of the risk-related predictions, within the first value range, is determined, and the contributions of the first input feature exhibit inconsistency that exceeds a defined threshold.

At block 720, the computing system trains a second tree-based ML model using the historical project delivery data as input data to identify a second input feature (e.g., “GLBL_BUY_GRP_KEY_LEAK_ACT”), where a combination of the first input feature and the second input feature resolves the inconsistent contributions of the first input feature, within the first value range.

At block 725, the computing system generates a knowledge base table (e.g., 240 of FIG. 2) comprising at least one of the first input feature, the second input feature, the first value range for the first input feature, and the combination of the first input feature and the second input feature.

In some embodiments, to identify the second input feature, the computing system may extract one or more data samples from the historical project delivery data, where the first input feature within the one or more data samples comprises values falling within the identified first value range, train the second tree-based ML model using the one or more data samples as input data, and identify, based on one or more decision paths within the second tree-based ML model with the first input feature excluded, a second value range for the second input feature, where a contribution of the second input feature to one or more of the risk-related predictions, within the second value range, is determined, and the contributions of the second input feature exhibit stability within a defined threshold.

In some embodiments, the knowledge base table may associate the first value range for the first input feature and the second value range for the second input feature with the combination.

In some embodiments, the knowledge base table may comprise a reason code associated with the combination of the first input feature and the second input feature, and a text-based explanation describing how the combination, within the first value range for the first input feature and the second value range for the second input feature, influences the risk-related predictions.

In some embodiments, the contribution of the first input feature to one or more of the risk-related predictions may comprise at least one of a possibility that the first input feature affects the risk-related prediction, a magnitude of an effect of the first input feature on the risk-related prediction, and a direction of the effect of the first input feature on the risk-related prediction, and where the direction is either positive or negative.

In some embodiments, the computing system may further receive real-time project data as input (e.g., 305 of FIG. 3) by the first tree-based ML model to generate a real-time risk-related prediction, determine that a value of the first input feature, extracted from the real-time project data, falls within the identified first value range for the first input feature (e.g., 0.48-0.52 for “DW_PRACTICE_LEAK_ACT”), determine that a value of the second input feature (e.g., 0-0.3 or 0.3-1 for “GLBL_BUY_GRP_KEY_LEAK_ACT”), extracted from the real-time project data, falls within the identified second value range for the second input feature, retrieve, from the knowledge base table (e.g., 240 of FIG. 4), the reason code associated with the combination, and output the reason code and the text-based explanation describing how the combination influences the real-time risk-related prediction.

In some embodiments, the computing system may identify, based on the one or more decision paths within the first tree-based ML model, a second value range for the first input feature (e.g., 0-0.48 or 0.52-1 for “DW_PRACTICE_LEAK_ACT”), where a contribution of the first input feature to one or more of the risk-related predictions, within the second value range, is determined, and the contributions of the first input feature exhibit stability falling within the defined threshold, and update the knowledge base table to associate the first input feature with the second value range, a reason code, and a text-based explanation describing how the first input feature, within the second value range, influences the risk-related predictions.

In some embodiments, the computing system may receive real-time project data as input data by the first tree-based ML model to generate a real-time risk-related prediction, determine that a value of the first input feature, extracted from the real-time project data, falls within the second value range for the first input feature, retrieve, from the knowledge base table, the reason code associated with the first input feature, and output the reason code and the text-based explanation describing how the first input feature influences the real-time risk-related prediction.

In some embodiments, to identify the second input feature, the computing system may extract one or more data samples from the historical project delivery data, where the first input feature within the one or more data samples comprises values falling within the identified first value range, train the second tree-based ML model using the data samples as input data, and identify, based on one or more decision paths within the second tree-based ML model with the first input feature excluded, a second value range for the second input feature, where a contribution of the second input feature to one or more of the risk-related predictions, within the second value range, is determined, and the contributions exhibit inconsistency that exceeds a defined threshold, and update the knowledge base table to associate the combination with the first value range for the first input feature, the second value range for the second input feature, a reason code, and a text-based explanation indicating conflicts are not resolved and describing a generic reason about how the first input feature, within the first value range for the first input feature, influences the risk-related predictions.

In some embodiments, the computing system may further receive real-time project data as input data by the first tree-based ML model to generate a real-time risk-related prediction, determine that a value of the first input feature, extracted from the real-time project data, falls within the identified first value range for the first input feature, determine that a value of the second input feature, extracted from the real-time project data, falls within the identified second value range for the second input feature, retrieve, from the knowledge base table, the reason code associated with the combination, and output the reason code and the text-based explanation indicating conflicts are not resolved and describing a generic reason about how the first input feature, within the first value range for the first input feature, influences the real-time risk-related prediction.

While the foregoing is directed to embodiments of the present invention, other and further embodiments of the invention may be devised without departing from the basic scope thereof, and the scope thereof is determined by the claims that follow.

What is claimed is:

1. A method, comprising:
training a first tree-based machine learning (ML) model using historical project delivery data as input data to generate one or more risk-related predictions for project performance;
determining a plurality of input features from the historical project delivery data;
identifying, based on one or more decision paths within the first tree-based ML model, a first value range for a first input feature, among the plurality of input features, wherein a contribution of the first input feature to one or more of the risk-related predictions, within the first value range, is determined, and the contributions of the first input feature exhibit inconsistency that exceeds a defined threshold;
training a second tree-based ML model using the historical project delivery data as input data to identify a second input feature, wherein a combination of the first input feature and the second input feature resolves the inconsistent contributions of the first input feature, within the first value range; and
generating a knowledge base table comprising at least one of the first input feature, the second input feature, the first value range for the first input feature, and the combination of the first input feature and the second input feature.

2. The method of claim 1, wherein identifying the second input feature comprises:
extracting one or more data samples from the historical project delivery data, wherein the first input feature within the one or more data samples comprises values falling within the identified first value range;
training the second tree-based ML model using the one or more data samples as input data; and
identifying, based on one or more decision paths within the second tree-based ML model with the first input feature excluded, a second value range for the second input feature, wherein a contribution of the second input feature to one or more of the risk-related predictions, within the second value range, is determined, and the contributions of the second input feature exhibit stability within a defined threshold.

3. The method of claim 2, wherein the knowledge base table associates the first value range for the first input feature and the second value range for the second input feature with the combination.

4. The method of claim 2, wherein the knowledge base table comprises a reason code associated with the combination of the first input feature and the second input feature, and a text-based explanation describing how the combination, within the first value range for the first input feature and the second value range for the second input feature, influences the risk-related predictions.

5. The method of claim 1, wherein the contribution of the first input feature to one or more of the risk-related predictions comprises at least one of a possibility that the first input feature affects the risk-related prediction, a magnitude of an effect of the first input feature on the risk-related prediction, and a direction of the effect of the first input feature on the risk-related prediction, and wherein the direction is either positive or negative.

6. The method of claim 4, further comprising:
receiving real-time project data as input by the first tree-based ML model to generate a real-time risk-related prediction;
determining that a value of the first input feature, extracted from the real-time project data, falls within the identified first value range for the first input feature;
determining that a value of the second input feature, extracted from the real-time project data, falls within the identified second value range for the second input feature;
retrieving, from the knowledge base table, the reason code associated with the combination; and
outputting the reason code and the text-based explanation describing how the combination influences the real-time risk-related prediction.

7. The method of claim 1, further comprising:
identifying, based on the one or more decision paths within the first tree-based ML model, a second value range for the first input feature, wherein a contribution of the first input feature to one or more of the risk-related predictions, within the second value range, is determined, and the contributions of the first input feature exhibit stability falling within the defined threshold; and
updating the knowledge base table to associate the first input feature with the second value range, a reason code, and a text-based explanation describing how the first input feature, within the second value range, influences the risk-related predictions.

8. The method of claim 7, further comprising:
receiving real-time project data as input data by the first tree-based ML model to generate a real-time risk-related prediction;
determining that a value of the first input feature, extracted from the real-time project data, falls within the second value range for the first input feature;
retrieving, from the knowledge base table, the reason code associated with the first input feature; and
outputting the reason code and the text-based explanation describing how the first input feature influences the real-time risk-related prediction.

9. The method of claim 1, wherein identifying the second input feature comprises:
extracting one or more data samples from the historical project delivery data, wherein the first input feature within the one or more data samples comprises values falling within the identified first value range;
training the second tree-based ML model using the data samples as input data;
identifying, based on one or more decision paths within the second tree-based ML model with the first input feature excluded, a second value range for the second input feature, wherein a contribution of the second input feature to one or more of the risk-related predictions, within the second value range, is determined, and the contributions exhibit inconsistency that exceeds a defined threshold; and
updating the knowledge base table to associate the combination with the first value range for the first input feature, the second value range for the second input feature, a reason code, and a text-based explanation indicating conflicts are not resolved and describing a generic reason about how the first input feature, within the first value range for the first input feature, influences the risk-related predictions.

10. The method of claim 9, further comprising:
receiving real-time project data as input data by the first tree-based ML model to generate a real-time risk-related prediction;
determining that a value of the first input feature, extracted from the real-time project data, falls within the identified first value range for the first input feature;
determining that a value of the second input feature, extracted from the real-time project data, falls within the identified second value range for the second input feature;
retrieving, from the knowledge base table, the reason code associated with the combination; and
outputting the reason code and the text-based explanation indicating conflicts are not resolved and describing a generic reason about how the first input feature, within the first value range for the first input feature, influences the real-time risk-related prediction.

11. A system, comprising:
one or more memories collectively containing one or more programs; and
one or more processors, wherein the one or more processors are configured to, individually or collectively, perform an operation comprising:
training a first tree-based machine learning (ML) model using historical project delivery data as input data to generate one or more risk-related predictions for project performance;
determining a plurality of input features from the historical project delivery data;
identifying, based on one or more decision paths within the first tree-based ML model, a first value range for a first input feature, among the plurality of input features, wherein a contribution of the first input feature to one or more of the risk-related predictions, within the first value range, is determined, and the contributions of the first input feature exhibit inconsistency that exceeds a defined threshold;
training a second tree-based ML model using the historical project delivery data as input data to identify a second input feature, wherein a combination of the first input feature and the second input feature resolves the inconsistent contributions of the first input feature, within the first value range; and
generating a knowledge base table comprising at least one of the first input feature, the second input feature, the first value range for the first input feature, and the combination of the first input feature and the second input feature.

12. The system of claim 11, wherein identifying the second input feature comprises:
extracting one or more data samples from the historical project delivery data, wherein the first input feature within the one or more data samples comprises values falling within the identified first value range;
training the second tree-based ML model using the one or more data samples as input data; and
identifying, based on one or more decision paths within the second tree-based ML model with the first input feature excluded, a second value range for the second input feature, wherein a contribution of the second input feature to one or more of the risk-related predictions, within the second value range, is determined, and the contributions of the second input feature exhibit stability within a defined threshold.

13. The system of claim 12, wherein the knowledge base table associates the first value range for the first input feature and the second value range for the second input feature with the combination.

14. The system of claim 12, wherein the knowledge base table comprises a reason code associated with the combination of the first input feature and the second input feature, and a text-based explanation describing how the combination, within the first value range for the first input feature and the second value range for the second input feature, influences the risk-related predictions.

15. The system of claim 11, wherein the contribution of the first input feature to one or more of the risk-related predictions comprises at least one of a possibility that the first input feature affects the risk-related prediction, a magnitude of an effect of the first input feature on the risk-related prediction, and a direction of the effect of the first input feature on the risk-related prediction, and wherein the direction is either positive or negative.

16. The system of claim 14, wherein the operation further comprises:
receiving real-time project data as input data by the first tree-based ML model to generate a real-time risk-related prediction;
determining that a value of the first input feature, extracted from the real-time project data, falls within the identified first value range for the first input feature;
determining that a value of the second input feature, extracted from the real-time project data, falls within the identified second value range for the second input feature;
retrieving, from the knowledge base table, the reason code associated with the combination; and
outputting the reason code and the text-based explanation describing how the combination influences the real-time risk-related prediction.

17. The system of claim 11, wherein the operation further comprises:
identifying, based on the one or more decision paths within the first tree-based ML model, a second value range for the first input feature, wherein a contribution of the first input feature to one or more of the risk-related predictions, within the second value range, is determined, and the contributions of the first input feature exhibit stability falling within the defined threshold; and
updating the knowledge base table to associate the first input feature with the second value range, a reason code, and a text-based explanation describing how the first input feature, within the second value range, influences the risk-related predictions.

18. The system of claim 17, wherein the operation further comprises:
receiving real-time project data as input data by the first tree-based ML model to generate a real-time risk-related prediction;
determining that a value of the first input feature, extracted from the real-time project data, falls within the second value range for the first input feature;
retrieving, from the knowledge base table, the reason code associated with the first input feature; and
outputting the reason code and the text-based explanation describing how the first input feature influences the real-time risk-related prediction.

19. One or more computer-readable media containing, in any combination, computer program code that, when executed by a computer system, performs an operation comprising:
training a first tree-based machine learning (ML) model using historical project delivery data as input data to generate one or more risk-related predictions for project performance;
determining a plurality of input features from the historical project delivery data;
identifying, based on one or more decision paths within the first tree-based ML model, a first value range for a first input feature, among the plurality of input features, wherein a contribution of the first input feature to one or more of the risk-related predictions, within the first value range, is determined, and the contributions of the first input feature exhibit inconsistency that exceeds a defined threshold;
training a second tree-based ML model using the historical project delivery data as input data to identify a second input feature, wherein a combination of the first input feature and the second input feature resolves the inconsistent contributions of the first input feature, within the first value range; and
generating a knowledge base table comprising at least one of the first input feature, the second input feature, the first value range for the first input feature, and the combination of the first input feature and the second input feature.

20. The one or more computer-readable media of claim 19, wherein identifying the second input feature comprises:
extracting one or more data samples from the historical project delivery data, wherein the first input feature within the one or more data samples comprises values falling within the identified first value range;
training the second tree-based ML model using the one or more data samples as input data; and
identifying, based on one or more decision paths within the second tree-based ML model with the first input feature excluded, a second value range for the second input feature, wherein a contribution of the second input feature to one or more of the risk-related predictions, within the second value range, is determined, and the contributions of the second input feature exhibit stability within a defined threshold.
